(19) United States
(12) Patent Application Publication
(10) Pub. No.: US 2007/0142149 A1
(43) Pub. Date: Jun. 21, 2007

(54) Pulley assembly and method

(76) Inventor: Richard M. Kleber, Clarkston, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/440,919

(22) Filed: May 25, 2006

Related U.S. Application Data
(60) Provisional application No. 60/739,578, filed on Nov. 23, 2005.

(51) Int. Cl. F16H 55/49

(52) U.S. Cl. 474/168

(57) ABSTRACT

The apparatus of the present invention provides an improved pulley assembly. The pulley assembly includes a ring portion having a frictional surface and a radially inner ring flange defining a plurality of ring teeth. The pulley assembly also includes a hub integrally formed onto the ring portion. The hub has a peripheral hub flange that includes a top portion and a bottom portion configured to trap the ring flange therebetween. The hub flange is also configured to engage the ring teeth and thereby prevent rotation of the hub relative to the ring portion. The ring portion is preferably composed of a first material such as steel or cast iron, and the hub is preferably composed of a second material such as aluminum or magnesium that is lighter by volume than the first material. Accordingly, the overall weight of the pulley assembly is less than that of a comparable pulley assembly composed entirely of steel or cast iron.

### CROSS-REFERENCE TO RELATED APPLICATIONS

This application claims priority to U.S. Provisional Patent Application No. 60/739,578 filed on Nov. 23, 2005.

### TECHNICAL FIELD

The present invention pertains generally to an improved pulley assembly and method for producing a pulley assembly.

### BACKGROUND OF THE INVENTION

It is well known to implement pulleys to transfer rotational energy from one device to another. Conventional pulleys are typically composed of cast iron or steel to support heavy loads and to resist wear. Cast iron and steel are, however, relatively heavy materials and pulleys composed of such materials are therefore also relatively heavy.

### SUMMARY OF THE INVENTION

The pulley assembly of the present invention includes a ring portion having a radially outer frictional surface, and a radially inner ring flange defining a plurality of ring teeth. The pulley assembly also includes a hub integrally formed onto the ring portion. The hub has a peripheral hub flange that includes a top portion and a bottom portion configured to trap the ring flange therebetween. The hub flange is also configured to engage the ring teeth and thereby prevent rotation of the hub relative to the ring portion. The ring portion is preferably composed of a first material such as steel or cast iron, and the hub is preferably composed of a second material such as aluminum or magnesium that is lighter by volume than the first material. Accordingly, the overall weight of the pulley assembly is less than that of a comparable pulley assembly composed entirely of steel or cast iron.

A preferred method for manufacturing the pulley assembly initially includes providing an upper tool having an upper sealing lip, and a lower tool having a lower sealing lip. A ring portion having a ring flange is then disposed within the lower tool. The upper and lower tools are then engaged such that a cavity is formed therebetween. According to a preferred embodiment, the upper tool, the lower tool and the ring portion are heated. A compressive force is preferably applied to draw the upper and lower tools together and thereby clamp the ring flange between the upper sealing lip and the lower sealing lip. Thereafter, material is transferred into the cavity formed between the upper and lower tools such that a hub is formed onto the ring portion.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a perspective view of a pulley assembly in accordance with the present invention;

FIG. 2 is a perspective view of a ring portion of the pulley assembly of FIG. 1;

FIG. 3 is a cross-sectional view of the pulley assembly of FIG. 1;

FIG. 4 is a cross-sectional view of upper and lower tools configured to produce the pulley assembly of FIG. 1; and

FIG. 5 is a cross-sectional view of the upper and lower tools of FIG. 4 in the closed position.

### DESCRIPTION OF THE PREFERRED EMBODIMENTS

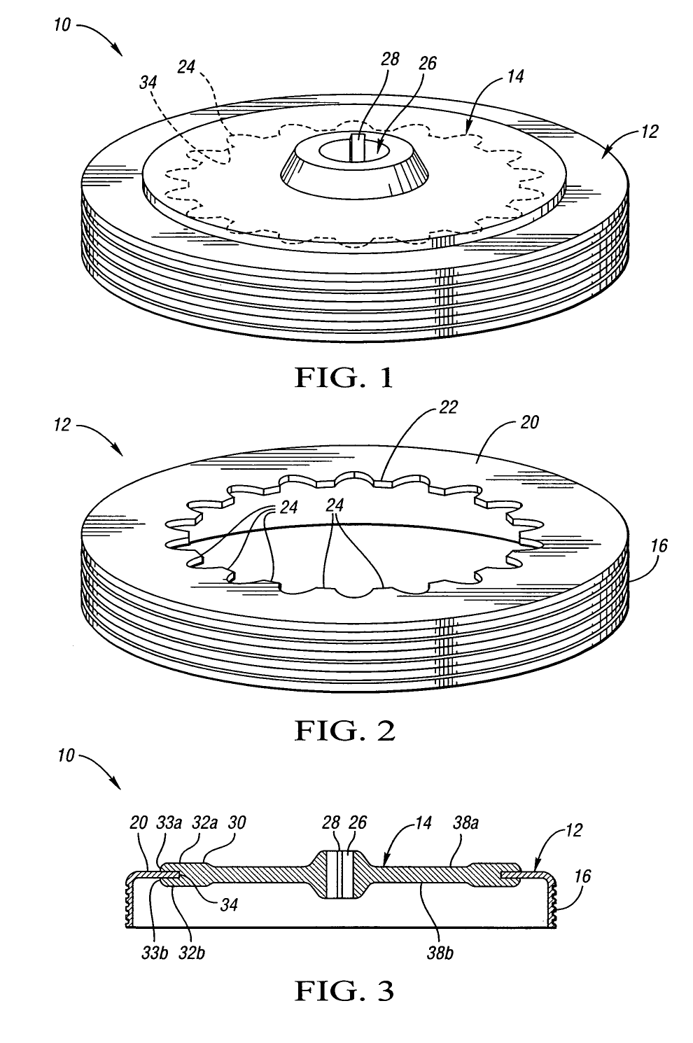

Referring to the drawings, wherein like reference numbers refer to like components, FIG. 1 shows a perspective view of a pulley assembly 10 in accordance with the present invention. The pulley assembly 10 includes a radially outer ring portion 12 and a radially inner hub 14 circumscribed by the ring portion 12. The pulley assembly 10 will hereinafter be described as a pulley assembly for an automotive accessory drive system; however, it should be appreciated that the pulley assembly 10 of the present invention is configured for other applications as well.

Referring to FIG. 2, the ring portion 12 is shown in more detail. The ring portion 12 includes a radially outer frictional surface 16 adapted for engagement by a device such as a belt (not shown). According to an embodiment wherein the frictional surface 16 is engaged by a belt, the belt may be of any known type including a belt having a generally rectangular cross-section or a belt having a v-shaped or triangular cross-section. A belt having a v-shaped cross section would be implemented with a notched radially outer frictional surface (not shown). The ring portion 12 has a radially inner ring flange 20 with an edge 22 having a plurality of ring teeth 24. The ring teeth 24 are adapted to engage complementary hub teeth 34 (shown in FIGS. 1 and 3) of the hub 14 and thereby resist rotation of the ring portion 12 relative to the hub 14.

An energy transfer device such as a belt engaged with a pulley tends to wear the pulley friction surface over time. Accordingly, the ring portion 12 is preferably composed of steel or cast iron as such materials provide good resistance to wear and are relatively inexpensive. It is well known; however, that steel and cast iron are relatively heavy materials and a conventional pulley assembly made exclusively of steel or cast iron is correspondingly heavy.

Referring to FIG. 3, a cross-sectional view of the pulley assembly 10 is shown. The hub 14 preferably defines a central aperture 26 and a locking element such as the key-hole 28 to facilitate the attachment of the pulley assembly 10 onto a shaft (not shown). The hub 14 has top surface 38a, and a bottom surface 38b. The hub 14 includes a peripheral hub flange 30 adapted to engage the ring flange 20 of the ring portion 12. The hub flange 30 includes top portion 32a and bottom portion 32b that are configured to trap the ring flange 20 therebetween. The top portion 32a and the bottom portion 32b respectively define radially outer terminal edges 33a and 33b. The hub flange 30 also includes a plurality of hub teeth 34 disposed between the top and bottom portions 32a, 32b. The hub teeth 34 are adapted to engage complementary ring teeth 24 (shown in FIG. 2) and thereby resist rotation of the ring portion 12 relative to the hub 14.

The engagement of the hub flange 30 with the ring flange 20 has been described in accordance with a preferred embodiment wherein the ring flange 20 is trapped between opposing portions 32a, 32b of the hub flange 30. It should be appreciated; however, that according to an alternate embodiment of the present invention, the geometry of the flange 20 may be replaced with that of flange 30 and vice versa. In other words, the ring flange 20 may include opposing portions (not shown) configured to trap the hub flange 30 therebetween.

The hub 14 is preferably composed of a material that weighs less for a given volume (i.e., is less dense) than the material of the ring portion 12 such that the complete pulley assembly 10 weighs much less than a conventional pulley assembly composed exclusively of steel or cast iron. According to the preferred embodiment, the hub is composed of Aluminum having a density of 2,700 kg/m³ or Magnesium having a density of 1,738 kg/m³, which are significantly lighter by volume than, for example, Iron having a density of 7874 kg/m³. Additionally, as described hereinabove, the friction surface 16 of the pulley assembly 10 which is engaged by a device such as a belt is preferably composed of steel or cast iron such that the pulley assembly 10 has strength and durability characteristics similar to those of a conventional pulley assembly composed exclusively of steel or cast iron.

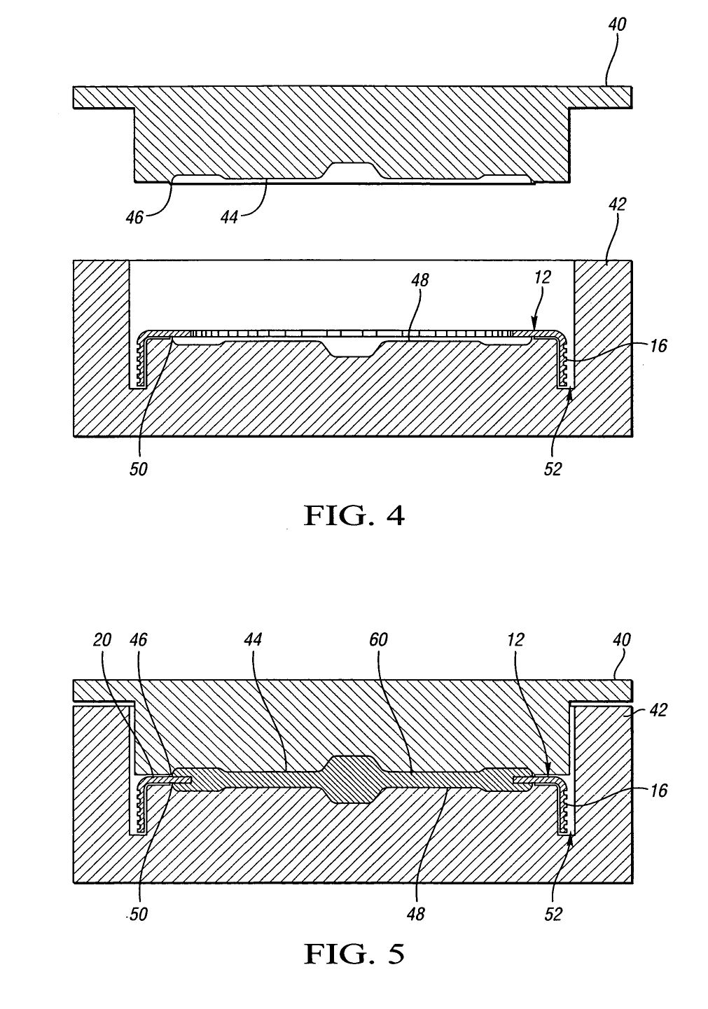

Referring to FIG. 4, a cross-sectional view of an upper tool 40 and a lower tool 42 configured to manufacture the pulley assembly 10 is shown. The upper tool 40 includes a tool surface 44 configured to form the top surface 38a of the hub 14 (shown in FIG. 3). The upper tool 40 also includes an upper sealing lip 46 configured to define the terminal edge 33a of the top portion 32a of the hub flange 30 (shown in FIG. 3). The lower tool 42 includes a tool surface 48 configured to form the bottom surface 38b of the hub 14 (shown in FIG. 3). The lower tool 42 also includes a lower sealing lip 50 configured to define the terminal edge 33b of the bottom portion 32b of the hub flange 30 (shown in FIG. 3). The lower tool 42 defines a ring cavity 52 configured to accommodate a ring element such as the ring portion 12.

Referring to FIG. 5, a cross-sectional view of the upper tool 40 engaged with the lower tool 42 is shown. A ring element such as the ring portion 12 is placed into the ring cavity 52 of the lower tool 42 before the upper and lower tools 40, 42 are engaged. A portion of the ring flange 20 is trapped between the sealing lip 46 of the upper tool 40 and the sealing lip 50 of the lower tool 42. The sealing lips 46, 50 define an outer perimeter of a cavity 60 formed between the tool surface 44 of the upper tool 40 and the tool surface 48 of the lower tool 42 when the upper and lower tools 40, 42 are engaged.

Having described the tooling and the apparatus of the present invention, the preferred method for manufacturing the pulley assembly 10 will hereinafter be described. The method of the present invention is preferably initiated by placing a ring element such as the ring portion 12 into the ring cavity 52 of the lower tool 42. The upper tool 40 and the lower tool 42 are then engaged to form the cavity 60. A compressive force is then preferably applied to draw the upper and lower tools 40, 42 together and thereby clamp the ring flange 20 between the sealing lips 46, 50 such that material introduced into the cavity 60 does not leak out. The upper and lower tools 40, 42, and the ring portion 12 are maintained at a predetermined elevated temperature such that molten material introduced into the cavity 60 does not prematurely cool upon contact with a relatively cold surface. Molten material such as aluminum or magnesium is then injected into the cavity 60 to form the hub 14 which is cast onto the ring portion 12 thereby producing the pulley assembly 10 (shown in FIG. 1). The introduction of molten material into the cavity 60 in the manner described forms the hub teeth 34 (shown in FIGS. 1 and 3) which mechanically interlock with the ring teeth 24 (shown in FIG. 2) to prevent rotation of the hub portion 14 relative to the ring portion 12. Additionally, as the molten material comes into contact with the ring portion 12, a welding or diffusion bonding process preferably takes place at the interface between the hub portion 14 and the ring portion 12 to further prevent relative rotation therebetween. After allowing the pulley assembly 10 to cool, the upper and lower tools 40, 42 are separated and the pulley assembly 10 is removed.

While the preferred method was described hereinabove, it should be appreciated that alternate and/or additional steps may be implemented as well. For example, instead of injecting molten material into the cavity 60, a semi-solid material may be introduced into the cavity 60 in accordance with the well known semi-solid forging process. Furthermore, after the pulley assembly 10 is removed from the lower tool 42, it may be necessary to perform processing steps such as, for example, machining the central aperture 26 and the key-hole 28 (shown in FIG. 1).

While the best modes for carrying out the invention have been described in detail, those familiar with the art to which this invention relates will recognize various alternative designs and embodiments for practicing the invention within the scope of the appended claims.

1. A pulley assembly comprising:
a ring portion including:
a radially outer frictional surface; and
a radially inner ring flange defining a plurality of ring teeth; and
a hub integrally formed onto said ring portion, said hub including a peripheral hub flange configured to engage said plurality of ring teeth to prevent rotation of the hub relative to the ring portion;
wherein said ring portion is composed of a first material and said hub is composed of a second material that is lighter by volume than said first material.

2. The pulley assembly of claim 1, wherein said first material is steel.

3. The pulley assembly of claim 1, wherein said second material is aluminum.

4. The pulley assembly of claim 1, wherein said second material is magnesium.

5. The pulley assembly of claim 1, wherein said hub defines a central aperture to facilitate the installation of the pulley assembly.

6. The pulley assembly of claim 1, wherein said hub defines a key-hole to facilitate the installation of the pulley assembly.

7. A method for producing a pulley assembly comprising:
providing an upper tool and a lower tool;
disposing a ring portion within said lower tool, said ring portion being composed of a first material;
engaging the upper and lower tools such that a cavity is formed therebetween; and
transferring a second material into the cavity formed between the upper and lower tools such that a hub composed of said second material is formed onto the ring portion;
wherein said second material is lighter by volume than said first material.

8. The method of claim 7, further comprising heating the upper tool, the lower tool and the ring portion before transferring material into the cavity.

9. The method of claim 8, wherein said transferring material into the cavity includes injecting molten aluminum into the cavity.

10. The method of claim 8, wherein said transferring material into the cavity includes injecting molten magnesium into the cavity.

11. The method of claim 8, wherein said transferring material into the cavity includes transferring semi-solid aluminum into the cavity.

12. The method of claim 8, further comprising machining a central aperture into the hub.

13. The method of claim 8, further comprising machining a key-hole into the hub.

14. A method for producing a pulley assembly comprising:
providing an upper tool having an upper sealing lip, and a lower tool having a lower sealing lip;
disposing a ring portion having a ring flange within said lower tool;
engaging the upper and lower tools such that a cavity is formed therebetween;
heating the upper tool, the lower tool and the ring portion;
applying a compressive force to draw the upper and lower tools together and thereby clamp the ring flange between the upper sealing lip and the lower sealing lip;
transferring material into the cavity formed between the upper and lower tools such that a hub is formed onto the ring portion.

15. The method of claim 14, wherein said transferring material into the cavity includes injecting molten aluminum into the cavity.

16. The method of claim 14, wherein said transferring material into the cavity includes injecting molten magnesium into the cavity.

17. The method of claim 14, wherein said transferring material into the cavity includes transferring semi-solid aluminum into the cavity.

18. The method of claim 14, further comprising machining a central aperture into the hub.

19. The method of claim 14, further comprising machining a key-hole into the hub.

20. An improved manufacture of multiple portions comprising:
a ring portion including:
a radially outer energy transfer surface; and
a radially inner energy transfer edge; and
a hub portion including at least one portion integrally formed onto said ring portion, said at least one portion of said hub portion including a peripheral hub flange configured to engage said energy transfer edge to sufficiently prevent rotation of the hub portion relative to the ring portion;
wherein said ring portion is composed of a first material and at least one portion of said hub portion is composed of a second material that is lighter by volume than said first material.
